(19) United States
(12) Patent Application Publication
(10) Pub. No.: US 2006/0209404 A1
(43) Pub. Date: Sep. 21, 2006

(54) Light-diffusing sheet having voids for TFT-LCD

(76) Inventors: Sang Pil Kim, Gumi-city (KR); Mun Bok Lee, Gumi-city (KR)

Correspondence Address: BELL, BOYD & LLOYD, LLC, PO BOX 1135, CHICAGO, IL, 60690-1135, US

(21) Appl. No.: 11/378,033

(22) Filed: Mar. 16, 2006

(30) Foreign Application Priority Data
Mar. 16, 2005 (KR) 2005-21969

(51) Int. Cl. G03B 21/60

(52) U.S. Cl. 359/453

(57) ABSTRACT

Disclosed herein is a light-diffusing sheet, composed of a base sheet including a synthetic resin and organic particles or inorganic particles, in which voids are formed around the organic or inorganic particles, a light-diffusing layer laminated on one surface of the base sheet, and an antiblocking layer laminated on the other surface of the base sheet. In the light-diffusing sheet of this invention, since the voids are formed around the organic or inorganic particles in the base sheet, light transmittance and light diffusibility are increased via maximizing scattering and reflection upon passing light through the base sheet, in particular, the voids, thus providing a light-diffusing sheet capable of increasing the light efficiency of a backlight unit. Thereby, in the case where the light-diffusing sheet of this invention is applied to a backlight unit of a TFT-LCD, vivid and distinct images are realized throughout the surface of the display.

### BACKGROUND

The present invention relates to a light-diffusing sheet for use in a backlight unit of a TFT-LCD (Thin Film Transistor-Liquid Crystal Display), and more particularly, to a light-diffusing sheet, in which organic or inorganic particles are contained in a base sheet thereof, and voids are formed around these particles, such that light passing through the base sheet is passed through the voids, thus increasing light transmittance and light diffusibility.

Recently, LCDs, which are image output devices that have low power consumption, low heat generation and high resolution and are manufacturable to be ultra slim, are receiving attention as image display devices in various industrial fields. However, in the display using liquid crystals, the liquid crystal itself is a non-emission material, unlike other flat displays, and an additional emission unit is thus required to increase the brightness of a display screen.

As the additional emission unit, emission units using a front-light process and a backlight process have been proposed. According to the front-light process, a light source is attached over the front surface or front lateral surface of the display to illuminate the surface of the display. However, as the size of the display is increased, technical problems, which entail difficulty in uniformly diffusing light over the front surface of the display, may occur. Further, due to the additional units attached to the front lateral surface of the display, limitations are imposed on designing the outer appearance of the display.

Meanwhile, the backlight process is an indirect lighting process for enhancing the brightness of a display screen in a manner such that light originating from the light source of a backlight unit mounted to the back surface of a display device is transferred to the opposite side through a light guide plate and then reflected at a reflective plate, such as a metal deposition plate or an opaque white plate, to allow the light to move forward. Thus, the backlight process is a light emission technique capable of overcoming the problems of the above-mentioned front-light process. As for the backlight process, when the number of light sources of a backlight unit is increased to realize high image brightness, power consumption and heat generation rates are increased. However, since maximum light efficiency should be realized using minimum power consumption, typical techniques for transferring light from a light source to a liquid crystal operator using a light-diffusing sheet, comprising a base sheet and a light-diffusing layer formed on at least one surface of the base sheet, have been proposed. As such, in the light-diffusing sheet, it is important to realize efficient design of the light-diffusing layer formed on the base sheet and to improve the functions thereof depending on such a design.

In regard to the light-diffusing sheet, Korean Patent Application No. 1992-14087 discloses a light-diffusing sheet comprising a base sheet and a light-diffusing layer composed of a synthetic resin and beads formed on the surface of the base sheet. In addition, Korean Patent Application No. 1996-38912 and Japanese Patent Laid-open Publication No. Hei. 07-174909 disclose a method of forming a layer of a transparent resin and organic particles on a transparent plastic sheet to increase light efficiency and luminance. However, such conventional techniques suffer because they have difficulty in actually realizing high luminance and shielding of LCDs, that is, improved total light transmittance and light diffusibility, merely through varying the combination of resin and particles applicable in the light-diffusing layer.

### SUMMARY

Leading to the present invention, intensive and thorough research into light-diffusing sheets, carried out by the present inventors aiming to avoid the problems encountered in the related art, resulted in the finding that, when preparing a base sheet of the light-diffusing sheet, organic particles or inorganic particles are contained in the base sheet composed of a synthetic resin as a main material of the base sheet, and voids are formed around the organic particles or inorganic particles, thereby obtaining a light-diffusing sheet having improved light transmittance and light diffusibility due to the presence of such voids.

Accordingly, an object of the present invention is to provide a light-diffusing sheet for a TFT-LCD, which has improved light transmittance and light diffusibility.

Another object of the present invention is to provide a light-diffusing sheet, in which organic or inorganic particles are contained in a base sheet and voids are formed around such particles, thus increasing light transmittance and light diffusibility.

In order to accomplish the above objects, the present invention provides a light-diffusing sheet, comprising a base sheet including a synthetic resin and organic particles or inorganic particles, in which voids are formed around the organic or inorganic particles; a light-diffusing layer laminated on one surface of the base sheet; and an antiblocking layer laminated on the other surface of the base sheet.

In the light-diffusing sheet, the voids satisfy Equation 1 below:

$$0.01 \leq \frac{size ( Sv ) of void formed around particle}{size ( Sp ) of particle} \leq 4 \qquad Equation 1$$

The base sheet having the voids is prepared in a manner such that the synthetic resin is mixed with the organic or inorganic particles, drawn 3˜5 times in a longitudinal direction and 4˜6 times in a width direction, and then thermoset at 220˜230° C.

As such, the organic particles may comprise at least one or more selected from the group consisting of acrylic resin, polyurethane, polyvinyl chloride, polystyrene, polyacrylonitrile, polyamide, and polymethylmethacrylate, and the inorganic particles may comprise at least one or more selected from the group consisting of titanium dioxide, zinc oxide, barium sulfate, silicon dioxide, calcium carbonate, magnesium carbonate, aluminum hydroxide, clay, calcium phosphate, and glass beads.

In the light-diffusing sheet, the light-diffusing layer preferably comprises 100 parts by weight of a light-diffusing resin composed of a thermosetting resin and 0.1˜50 parts by weight of light-diffusing particles, and the light-diffusing layer is preferably 0.2˜500 μm thick.

In the light-diffusing sheet, the antiblocking layer preferably comprises 100 parts by weight of an antiblocking resin composed of a thermosetting resin and 0.01˜500 parts by weight of antiblocking particles, and the antiblocking layer is preferably 0.1˜100 μm thick.

The thermosetting resin used as the light-diffusing resin or antiblocking resin may comprise at least one or more selected from the group consisting of urea resin, melamine resin, phenol resin, epoxy resin, unsaturated polyester resin, alkyd resin, urethane resin, acrylic resin, polyurethane, fluorine resin, silicon resin, and polyamideimide.

The light-diffusing particles or antiblocking particles may comprise at least one or more selected from the group consisting of acrylic resin, polyurethane, polyvinyl chloride, polystyrene, polyacrylonitrile, polyamide, and polymethylmethacrylate, and are preferably in spherical form.

Additional features and advantages are described herein, and will be apparent from, the following Detailed Description and the figures.

### BRIEF DESCRIPTION OF THE FIGURES

FIG. 1 is a cross-sectional view schematically showing a light-diffusing sheet having voids, according to the present invention; and

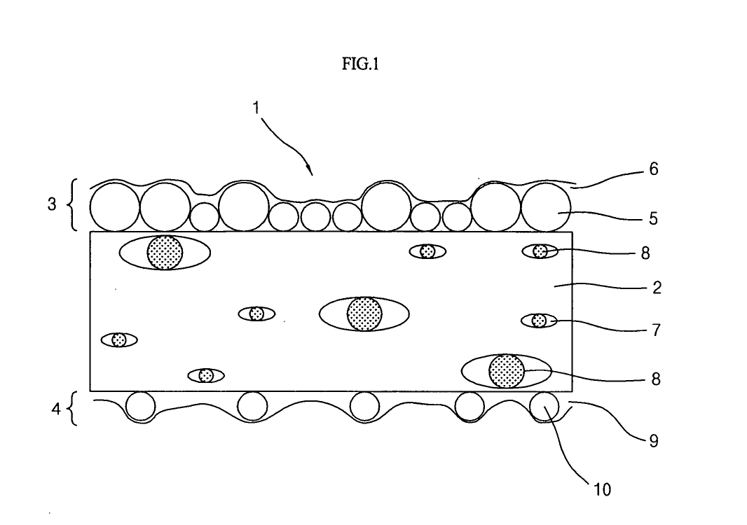

FIG. 2 is a cross-sectional view schematically showing the particle of the light-diffusing sheet of the present invention and the void formed around such a particle.

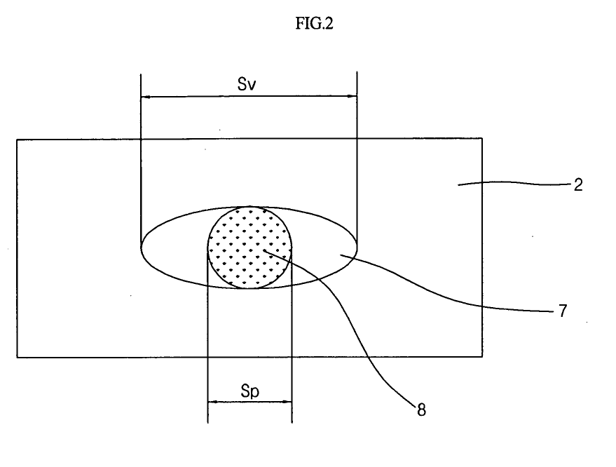

### DETAILED DESCRIPTION

Hereinafter, a detailed description will be given of the present invention.

A light-diffusing sheet 1 of the present invention comprises a base sheet 2 composed of a synthetic resin; a light-diffusing layer 3 laminated on one surface of the base sheet 2; and an antiblocking layer 4 laminated on the other surface of the base sheet 2, the base sheet 2 containing organic or inorganic particles 8 in addition to the synthetic resin, and voids being formed around the organic or inorganic particles.

For the base sheet 2 of the present invention, useful is a synthetic resin having high light transmittance in order to more advantageously transmit light emitted from a light source. As such, the synthetic resin is not particularly limited but preferably is any one selected from the group consisting of polyethyleneterephthalate, polyethylenenaphthalate, acrylic resin, polycarbonate, polystyrene, polyolefin, and cellulose acetate.

The thickness of the base sheet 2 is not particularly limited, but is preferably 10˜500 μm, and more preferably 75˜250 μm. If the base sheet 2 is thinner than 10 μm, a curling phenomenon may be easily caused by the resin composition constituting the light-diffusing layer 3. On the other hand, if the base sheet 2 is thicker than 500 μm, the luminance of the LCD is decreased and the backlight unit becomes so thick as to be unsuitable for use in manufacturing a slim LCD.

In addition, the base sheet 2 includes the organic or inorganic particles 8, in addition to the synthetic resin, and voids 7 having a predetermined size are formed around the organic or inorganic particles 8.

The inorganic particles preferably comprise at least one or more selected from the group consisting of titanium dioxide, zinc oxide, barium sulfate, silicon dioxide, calcium carbonate, magnesium carbonate, aluminum hydroxide, calcium phosphate, clay, and glass beads. The organic particles preferably are at least one or more selected from the group consisting of acrylic resin, polyurethane, polyvinyl chloride, polystyrene, polyacrylonitrile, polyamide, and polymethylmethacrylate.

The present invention is characterized in that the voids 7 are formed around the organic or inorganic particles contained in the base sheet 2 composed of the synthetic resin, and thus light passing through the base sheet 2, or, more precisely, light passing through the voids 7, is maximally scattered and reflected, thus further increasing the diffusibility of the light-diffusing sheet.

The voids 7 formed in the base sheet of the light-diffusing sheet of the present invention satisfy Equation 1 represented below:

$$0.01 \leq \frac{size ( Sv ) of void formed around particle}{size ( Sp ) of particle} \leq 4 \qquad Equation 1$$

As such, if the relation between the sizes of particles and voids formed around such particles is less than 0.01, the improvement in diffusibility owing to the voids becomes insignificant. On the other hand, if the above relation exceeds 4, diffusibility is good but total light transmittance is drastically decreased, resulting in poor luminance of LCDs.

The base sheet having the voids is prepared in a manner such that the synthetic resin is mixed with the organic or inorganic particles, drawn 3˜5 times in a longitudinal direction and 4˜6 times in a width direction, and then thermoset at 220˜230° C.

The light-diffusing sheet 1 of the present invention has the light-diffusing layer 3 composed of a light-diffusing resin 6 and light-diffusing particles 5. The light-diffusing resin 6 preferably comprises a thermosetting resin which is easily handled and available. Examples of the thermosetting resin include, but are not limited to, any one selected from the group consisting of urea resin, melamine resin, phenol resin, epoxy resin, unsaturated polyester resin, alkyd resin, urethane resin, acrylic resin, polyurethane, fluorine resin, silicon resin, and polyamideimide. Moreover, the resin should be preferably colorless and transparent, since light should be transmitted therethrough. In addition, the light-diffusing resin may further include a plasticizer, a stabilizer, a deterioration preventing agent, a dispersant, an antifoaming agent, or a foaming agent, in addition to the above-mentioned resin, if necessary.

The light-diffusing particles 5 used in the light-diffusing layer 3 comprise at least one or more selected from the group consisting of acrylic resin, polyurethane, polyvinyl chloride, polystyrene, polyacrylonitrile, polyamide, and polymethylmethacrylate, and are preferably in spherical form. More preferably, the light-diffusing particles should be colorless and transparent so as to maximize the amount of light passing through the light-diffusing sheet.

The light-diffusing particles have a diameter of 0.1˜100 μm, preferably 0.1˜50 μm, and more preferably 0.1˜10 μm. If the diameter is less than 0.1 μm, the light-diffusing effect becomes insignificant. On the other hand, if the diameter exceeds 100 μm, the resin composition constituting the light-diffusing layer is difficult to apply and the particles may become detached from the laminated light-diffusing layer.

In order to manufacture a light-diffusing sheet having total light transmittance of 85˜95% via control of the optical properties of the light-diffusing layer 3, the ratio of light-diffusing resin 6 and light-diffusing particles 5 is adjusted. That is, the light-diffusing layer 3 is formed such that the light-diffusing particles 5 are used in an amount of 0.1˜50 parts by weight, preferably 0.1˜30 parts by weight, and more preferably 0.1˜15 parts by weight, based on 100 parts by weight of the light-diffusing resin 6. If the amount of light-diffusing particles 5 is less than 0.1 parts by weight, the light-diffusing effect is reduced. On the other hand, if the amount exceeds 50 parts by weight, the light-diffusing resin composition constituting the light-diffusing layer is difficult to apply.

In the light-diffusing sheet 1 of the present invention, the thickness of the light-diffusing layer 3 is adjusted, thereby controlling the light transmittance. In particular, with the intention of manufacturing a light-diffusing sheet having total light transmittance of 85˜95%, the light-diffusing layer 3 is applied to a thickness of 0.2˜500 μm, and preferably 2˜200 μm. If the light-diffusing layer is applied to a thickness less than 0.2 μm, it has low adhesion to the sheet upon application, and the light-diffusing particles may become detached from the laminated light-diffusing layer. On the other hand, if the applied layer is thicker than 500 μm, total light transmittance is not higher than 84%, and thus a desired light-diffusing sheet cannot be manufactured.

The light-diffusing sheet 1 of the present invention has the antiblocking layer 4 composed of an antiblocking resin 9 and antiblocking particles 10. The antiblocking resin 9 usable in the antiblocking layer 4 preferably includes the same thermosetting resin as the light-diffusing resin 6, which is exemplified by any one selected from the group consisting of urea resin, melamine resin, phenol resin, epoxy resin, unsaturated polyester resin, alkyd resin, urethane resin, acrylic resin, polyurethane, fluorine resin, silicon resin, and polyamideimide. The antiblocking resin 9 should be colorless and transparent since light must be transmitted therethrough.

In addition, a plasticizer, a stabilizer, a deterioration preventing agent, a dispersant, an antifoaming agent, a foaming agent or a waxing agent may be further used.

Further, the antiblocking particles 10 used in the antiblocking layer 4, which are the same as the light-diffusing particles 5, include at least one or more selected from the group consisting of acrylic resin, polyurethane, polyvinyl chloride, polystyrene, polyacrylonitrile, polyamide, and polymethylmethacrylate. The antiblocking particles 10 are preferably spherical. As well, the antiblocking particles 10 should be preferably colorless and transparent in order to maximize the amount of light passing through the light-diffusing sheet. The particles 10 have a diameter of 0.1˜100 μm, and preferably 1˜50 μm. If the diameter of antiblocking particles 10 is less than 0.1 μm, a blocking phenomenon, which impedes the travel of the film, may occur during the process. On the other hand, if the diameter of antiblocking particles exceeds 100 μm, the resin composition constituting the antiblocking layer is difficult to apply, and also the antiblocking particles may become detached from the laminated antiblocking layer.

The antiblocking layer 4 is formed such that the antiblocking particles 10 are used in an amount of 0.01˜500 parts by weight, and preferably 0.1˜100 parts by weight, based on 100 parts by weight of the antiblocking resin 9. If the amount of antiblocking particles 10 is less than 0.01 parts by weight, a blocking phenomenon, which impedes the travel of the film, may occur during the process. On the other hand, if the above amount exceeds 500 parts by weight, it is difficult to apply the resin composition constituting the antiblocking layer 4.

In order to assure high light transmittance and antiblocking function and to obtain total light transmittance of 85˜95%, the antiblocking layer 4 is applied to a thickness of 0.1˜100 μm, preferably 0.1˜50 μm, and more preferably 0.2˜20 μm. If the antiblocking layer 4 is applied to a thickness of less than 0.1 μm, it has low adhesion to the base sheet upon application, and also the antiblocking particles may be detached from the laminated antiblocking layer. On the other hand, if the antiblocking layer 4 is thicker than 100 μm, total light transmittance is decreased to 84% or less, and it is impossible to manufacture a desired light-diffusing sheet.

In addition, of the process of assembling BLU using a light-diffusing sheet, an antistatic agent may be added to or applied on the antiblocking layer of the light-diffusing sheet to prevent the introduction of impurities due to static electricity. As such, the antistatic agent should be appropriately selected in consideration of antistatic function and heat resistance, and may be exemplified by a cationic antistatic agent, an anionic antistatic agent, an amphoteric antistatic agent, a nonionic antistatic agent, a polymer-type antistatic agent, etc. Preferably, the cationic antistatic agent is selected from the group consisting of quarternary ammonium salts, pyridinium salts, and mono-, sec-, and tert-amino groups, and the anionic antistatic agent is selected from the group consisting of sulfonates, sulfate esters, phosphate esters, and phosphonates.

Hereinafter, the present invention is specifically explained using the following examples which are set forth to illustrate, but are not to be construed to limit the present invention.

### EXAMPLE 1

### Manufacture of Light-Diffusing Sheet 1

Step 1: Preparation of Base Sheet

A polyester resin containing silicon dioxide particles, having a diameter of 0.4 μm and mixed during the polymerization, was dried in a vacuum, melted and extruded using an extruder, after which the melted hot polyester resin was formed into a sheet using a rotary cooling roll via a die. As such, the polymer was brought into close contact with the cooling roll using an electrostatic application process, thereby obtaining an undrawn polyester sheet. While the undrawn polyester sheet was passed on a roll preheated to 70˜120° C., it was drawn three times in a longitudinal direction, thus obtaining a uniaxially drawn polyester film. Both edges of the uniaxially drawn polyester film were held by clips, after which this film was fed into a region heated to 80˜150° C., and then hot air was blasted onto upper and lower portions of the film to supply heat so as to draw the film five times in a width direction. Subsequently, the film was fed into a higher temperature region, that is, was thermoset at 220° C. for crystal orientation, thus forming voids having a size of 0.8 μm.

Step 2: Formation of Light-Diffusing Layer

A light-diffusing layer composition comprising the components shown in Table 1 below was applied on one surface of a highly transparent polyester film (XG533-100 um, available from Toray Saehan Inc.) as the base sheet prepared in step 1 and was then dried at 110° C. for 60 sec, thus forming a 30 μm thick light-diffusing layer.

TABLE 1

| Total Weight of Composition | | | 100 | g |
|---|---|---|---|---|
| Composition | Light- | Acrylic Resin | 30 | g |
| | Diffusing | (A-811, Aekyung | | |
| | Resin | Chemical Co. Ltd.) | | |
| | Light- | Acrylic Particles | 30 | g |
| | Diffusing | (SOKEN MX1000) | | |
| | Particles | | | |
| | Solvent | Methylethylketone | 40 | g |

Step 3: Formation of Antiblocking Layer

An antiblocking layer composition comprising the components shown in Table 2 below was applied on the opposite surface of the base sheet having the light-diffusing layer and was then dried at 110° C. for 40 sec, thus forming a 5 μm thick antiblocking layer, thereby manufacturing a light-diffusing sheet.

TABLE 2

| Total Weight of Composition | | | 100 | g |
|---|---|---|---|---|
| Composition | Antiblocking | Acrylic Resin | 28 | g |
| | Resin | (A-811, Aekyung | | |
| | | Chemical Co. Ltd.) | | |
| | Antiblocking | Acrylic Particles | 0.5 | g |
| | Particles | (SOKEN MX300) | | |
| | Solvent | Methylethylketone | 70 | g |
| | Antistatic | Anionic Antistatic Agent | 1.5 | g |
| | Agent | (CHEMISTAT) | | |

### EXAMPLE 2

### Manufacture of Light-Diffusing Sheet 2

A light-diffusing sheet having 1.2 μm-sized voids was manufactured in the same manner as in Example 1, with the exception that silicon dioxide particles having a diameter of 0.4 μm were used and the draw ratio was changed to 4×5 times in step 1 for preparation of the base sheet.

### EXAMPLE 3

### Manufacture of Light-Diffusing Sheet 3

A light-diffusing sheet having 1.4 μm-sized voids was manufactured in the same manner as in Example 1, with the exception that silicon dioxide particles having a diameter of 0.6 μm were used and the draw ratio was changed to 4×6 times in step 1 for preparation of the base sheet.

### COMPARATIVE EXAMPLE 1

A light-diffusing sheet having 6.3 μm-sized voids was manufactured in the same manner as in Example 1, with the exception that silicon dioxide particles having a diameter of 1.2 μm were used, the draw ratio was set to 3×5 times, and the thermosetting temperature for crystal orientation was changed to 200° C. in step 1 for preparation of the base sheet.

### COMPARATIVE EXAMPLE 2

A light-diffusing sheet having 16.0 μm-sized voids was manufactured in the same manner as in Example 1, with the exception that silicon dioxide particles having a diameter of 3.5 μm were used, the draw ratio was changed to 6×5 times, and the thermosetting temperature for crystal orientation was changed to 200° C. in step 1 for preparation of the base sheet.

### COMPARATIVE EXAMPLE 3

A light-diffusing sheet having 0.001 μm-sized voids was manufactured in the same manner as in Example 1, with the exception that silicon dioxide particles having a diameter of 1.0 μm were used, the draw ratio was set to 3×5 times, and the thermosetting temperature for crystal orientation was changed to 240° C. in step 1 for preparation of the base sheet.

### EXPERIMENTAL EXAMPLE

1. Measurement of Size of Void

The diameters of voids formed in the base sheet of the light-diffusing sheet manufactured in Example 1 were measured. The base sheet was pretreated using a plasma surface treating device, and the sizes of particles and voids formed around the particles were measured at 3000 power magnification using an electron microscope, available from JOL.

2. Measurement of Total Light Transmittance

The light transmittance and light diffusibility of the light-diffusing sheet manufactured in Example 1 were determined according to the following procedures. While light of 550 nm was transmitted perpendicular to a 10 cm×10 cm sized light-diffusing sheet sample which had been stood upright, the amount of light was measured using an automatic digital hazemeter, available from Nippon Denshoku Industries Co., Ltd. The total light transmittance was calculated from Equation 2 below:

$$Total Light Transmittance ( \% ) = ( \frac{totally transmitted amount of light}{amount of incident light} ) ⨯ 100 \qquad Equation 2$$

3. Measurement of Light Diffusibility

The light diffusibility of the light-diffusing sheet manufactured in Example 1 was measured according to the following procedures. A light-diffusing sheet sample was cut and then mounted on a light-diffusing plate of a 32″ direct type backlight unit. Then, a BM-7, as a luminance meter available from Topcon Corporation, was provided such that the measurement angle was set to 0.2° and the interval between the backlight unit and the BM-7 was set to 25 cm, after which luminance was measured at 13 positions on lamps of the backlight unit and 12 positions between the lamps. Then, the luminance average at the lamps and the luminance average between the lamps were determined and the difference therebetween was represented by light diffusibility. In addition, the difference in luminance average (luminance average at the lamps−luminance average between the lamps) was classified into the following criteria, to evaluate light diffusibility:

Δ (difference in luminance average)<1: good

Δ (difference in luminance average)≧1: poor

TABLE 3
Results of Measurement of Properties of Light-Diffusing Sheets
of Examples 1˜3 and Comparative Examples 1˜3

| | Base Sheet | | | | | Light-Diffusing Sheet | | | |
|---|---|---|---|---|---|---|---|---|---|
| | Preparation | | | | | | Light-Diffusi. | | |
| | Process | | Properties | | | Total | Δ (cd/m²) | | |
| | | Thermo- | Size of | Size of | | Light | (Difference in | | |
| | Draw | setting | Void | Particle | K | Transmit. | Luminan. | | |
| | Ratio | (° C.) | (Sv: μm) | (Sp: μm) | (Sv/Sp) | (%) | Average) | Assay | Assay |
| Ex. 1 | 3 × 5 | 220 | 0.8 | 0.4 | 2 | 94 | 0.7 | Good | Good |
| Ex. 2 | 4 × 5 | 220 | 1.2 | 0.4 | 3 | 92 | 0.5 | Good | Good |
| Ex. 3 | 4 × 6 | 220 | 1.4 | 0.6 | 2.3 | 92 | 0.5 | Good | Good |
| C. Ex. 1 | 3 × 5 | 200 | 6.3 | 1.2 | 5.25 | 84 | 0.2 | Good | Poor |
| C. Ex. 2 | 6 × 5 | 200 | 16 | 3.5 | 4.57 | 78 | 0.4 | Good | Poor |
| C. Ex. 3 | 3 × 5 | 240 | 0.001 | 1.0 | 0.001 | 93 | 2.5 | Poor | Poor |

As is apparent from Table 3, both the total light transmittance and the light diffusibility of the light-diffusing sheets manufactured in Examples 1˜3 were good. However, in Comparative Examples 1 and 2, in which the sizes of particles and voids were excessively enlarged, the total light transmittance was very low. In addition, in Comparative Example 3, in which few voids were formed, light diffusiblity was confirmed to be very low.

As mentioned above, the present invention provides a light-diffusing sheet having voids, which is excellent with respect both to total light transmittance and to light diffusibility. Therefore, the light-diffusing sheet of the present invention can be used as an optical material for improving the light efficiency of a backlight unit of a TFT-LCD.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A light-diffusing sheet, comprising:
a base sheet, including a synthetic resin and a particle selected from the group consisting of an organic particle and an inorganic particle, in which voids are formed around the particle;
a light-diffusing layer laminated on one surface of the base sheet; and
an antiblocking layer laminated on a second surface of the base sheet.

2. The light-diffusing sheet as set forth in claim 1, wherein the void satisfies Equation 1 below:
$$0.01 \leq \frac{size ( Sv ) ) of void formed around particle}{size ( Sp ) of particle} \leq 4 \qquad Equation 1$$

3. The light-diffusing sheet as set forth in claim 1, wherein the base sheet having the voids is prepared in a manner such that the synthetic resin is mixed with the particle, drawn 3 to 5 times in a longitudinal direction and 4 to 6 times in a width direction, and then thermoset at 220 to 230° C.

4. The light-diffusing sheet as set forth in claim 1, wherein the particles comprise at least one or more particles selected from the group consisting of acrylic resin, polyurethane, polyvinyl chloride, polystyrene, polyacrylonitrile, polyamide, and polymethylmethacrylate.

5. The light-diffusing sheet as set forth in claim 1, wherein the particles comprise at least one or more particles selected from the group consisting of titanium dioxide, zinc oxide, barium sulfate, silicon dioxide, calcium carbonate, magnesium carbonate, aluminum hydroxide, clay, calcium phosphate, and glass beads.

6. The light-diffusing sheet as set forth in claim 1, wherein the light-diffusing layer comprises 100 parts by weight of a light-diffusing resin composed of a thermosetting resin and 0.1 to 50 parts by weight of light-diffusing particles having a diameter of 0.1 to 100 μm.

7. The light-diffusing sheet as set forth in claim 1, wherein the light-diffusing layer is 0.2 to 500 μm thick.

8. The light-diffusing sheet as set forth in claim 1, wherein the antiblocking layer comprises 100 parts by weight of an antiblocking resin composed of a thermosetting resin and 0.01 to 500 parts by weight of antiblocking particles having a diameter of 0.1 to 100 μm.

9. The light-diffusing sheet as set forth in claim 1, wherein the antiblocking layer is 0.1 to 100 μm thick.

10. The light-diffusing sheet as set forth in claim 6, wherein the thermosetting resin is at least one or more resins selected from the group consisting of urea resin, melamine resin, phenol resin, epoxy resin, unsaturated polyester resin, alkyd resin, urethane resin, acrylic resin, polyurethane, fluorine resin, silicon resin, and polyamideimide.

11. The light-diffusing sheet as set forth in claim 6, wherein the particles comprise at least one or more particles selected from the group consisting of urea resin, melamine selected from the group consisting of acrylic resin, polyurethane, polyvinyl chloride, polystyrene, polyacrylonitrile, polyamide, and polymethylmethacrylate, and are in spherical form.

12. The light-diffusing sheet as set forth in claim 8, wherein the thermosetting resin is at least one or more resins selected from the group consisting of urea resin, melamine resin, phenol resin, epoxy resin, unsaturated polyester resin, alkyd resin, urethane resin, acrylic resin, polyurethane, fluorine resin, silicon resin, and polyamideimide.

13. The light-diffusing sheet as set forth in claim 8, wherein the particles comprise at least one or more particles selected from the group consisting of urea resin, melamine selected from the group consisting of acrylic resin, polyurethane, polyvinyl chloride, polystyrene, polyacrylonitrile, polyamide, and polymethylmethacrylate, and are in spherical form.
